(19) United States
(12) Patent Application Publication
(10) Pub. No.: US 2019/0050890 A1
(43) Pub. Date: Feb. 14, 2019

(54) VIDEO DOTTING PLACEMENT ANALYSIS SYSTEM, ANALYSIS METHOD AND STORAGE MEDIUM

(71) Applicant: Viscovery (Cayman) Holding Company Limited, Grand Cayman (KY)

(72) Inventors: Yun-Fu LIU, Taipei City (TW); Shao-Hang HSIEH, Taipei City (TW); Chien-Yu LIN, Taipei City (TW); Chun-Chieh HUANG, Taipei City (TW)

(21) Appl. No.: 15/942,926

(22) Filed: Apr. 2, 2018

(30) Foreign Application Priority Data
Aug. 9, 2017 (CN) 201710675073.4

(51) Int. Cl. G06Q 30/02

(52) U.S. Cl. CPC G06Q 30/0242; G06F 17/2785

(57) ABSTRACT

A video dotting placement analysis method is disclosed, including: converting a content of the video into a plurality of descriptor lists, wherein each descriptor list is recorded with a time sequence and a plurality of raw descriptors; providing an advertisement category (ADC) model recorded with relationships among a plurality of advertisement categories and a plurality of descriptors; performing analysis on the ADC model and the plurality of descriptor lists to generate a plurality of ADC recommendation lists, wherein the plurality of ADC recommendation lists is recorded with category relevance confidences between each advertisement category and the video content corresponded to each time sequences; calculating predicted audience response (AR) values of each advertisement category; and analyzing one or multiple time sequences as a dotting placement of the video based on the plurality of ADC recommendation lists, the plurality of predicted AR values and a dotting model.

### FIELD OF INVENTION

The present disclosure pertains to a video analysis system, analysis method and storage medium thereof, particularly a video dotting analysis system, analysis method and storage medium.

### BACKGROUND OF RELATED ART

Advertising is the best way of attracting consumers spending or promoting particular campaigns. Due to the advancement of internet, the advertising market for digital advertising is competitive. Specifically, other than the traditional banner with text advertisements on the webpages, advertisers also embed advertisements/commercials/creatives in the videos.

In order to increase the advertising effect, the advertisers need to make sure the creative is having a good relevance with the video content at the marked placement so the advertisers usually employ people to interpret the video content manually before deciding where to place the ad marks to embed the creative in order for the suitable ad placement in the video can be found for a specific creative with specific content. This act of marking the ad placement on the video timeline or placing ad mark on the timeline of the video to insert or embed an advertisement is described as “dot”, “dotting” or “dotted” hereinafter.

However, there is no objective standard for determining a suitable dotting placement with human involvement. Different people with different level of experiences might determine different placements as the suitable dotting placements for the same video. Furthermore, people are judgmental with their own preferences in determining the dotting placement (i.e. the relevance of said dotting placement and the content of the embedded advertisement is low or the relevance is high but not up to the preferences of general audiences) so the dotted placement might not be determined according to the preference of majority audiences or following the profile obtained after analyzing preference data of the majority audiences.

As mentioned above, there exist risks of consumers perceiving negative impression for the product advertised if the advertiser bought the unsuitable dotting placement to promote the product and hence the advertising budget is wasted or the brand image is damaged.

Furthermore, the cost for manually dotting the video is high and the cost will increase in folds if there is a mass amount of videos to be dotted. This also greatly decreases the advertising cost effectiveness.

### SUMMARY OF THE INVENTION

One of the purposes of the present disclosure is to provide a video dotting analysis system, analysis method and storage medium that may search or determine the dotting placement in a video automatically according to the content of the video, various advertisement categories (ADCs) and predicted audience response (AR) values for each ADC (such as click-through rate, conversion rate, retention rate). At the same time, the most relevant ADCs for the dotted placement are suggested or recommended. By doing so, the content relevance between the video and the advertisement is high and hence the advertising effect is maximized.

To achieve the mentioned purpose, the present disclosure provides a video dotting placement analysis method, including the steps of: a) providing a video; b) converting a content of the video into a plurality of descriptor lists, wherein each of the descriptor lists is recorded with a time sequence and a plurality of raw descriptors respectively, and the plurality of raw descriptors is used for describing a plurality of features of the video appeared in the time sequence; c) providing an advertisement category model, wherein the advertisement category model is recorded with relationships among a plurality of advertisement categories and a plurality of descriptors; d) performing analysis based on the advertisement category model and the plurality of descriptor lists in order to generate a plurality of advertisement category recommendation lists, wherein a quantity of the plurality of advertisement category recommendation lists is identical to a quantity of the plurality of descriptor lists, and each of the advertisement category recommendation lists is respectively recorded with category relevance confidences between each of the plurality of advertisement categories and a video content corresponding to each of the time sequences; e) calculating predicted audience response (AR) values of each of the advertisement categories; and f) analyzing one or multiple of the time sequences as a dotting placement of the video based on the plurality of advertisement category recommendation lists, the plurality of predicted audience response values and a dotting model.

As mentioned above, the method may further include the steps of: g1) after Step b, providing a descriptor semantic model formed by a plurality of base descriptors and a plurality of edges with a direction, wherein each base descriptor respectively corresponds to a predefined feature, the plurality of edges define relational strengths among the plurality of base descriptors, and the plurality of base descriptors respectively comprise the plurality of raw descriptors and the plurality of advertisement categories; and g2) obtaining one of the plurality of descriptor lists, and calculating and generating a inferred descriptor list based on the descriptor semantic model and the descriptor list obtained, wherein the inferred descriptor list is recorded with the plurality of inferred descriptors, the plurality of raw descriptors, descriptor relevance confidences between each of the inferred descriptors and raw descriptors and the video content corresponding to the time sequence of the obtained descriptor list; wherein, Step d is to perform analysis based on the plurality of advertisement categories and the inferred descriptor list in order to generate one of the advertisement category recommendation lists.

The above mentioned Step d may further include the steps of: d1) selecting one of the plurality of inferred descriptor lists and performing matching with the plurality of advertisement categories in the advertisement category model in order to respectively calculate the category relevance confidences between each of the plurality of advertisement categories and the video content corresponding to the selected inferred descriptor list; d2) determining whether all of the plurality of inferred descriptor lists are matched completely; and d3) before all of the plurality of inferred descriptor lists are matched completely, selecting a next one of the inferred descriptor lists for executing Step d1 again.

Furthermore, the above mentioned Step d1 may include the steps of: d11) selecting one of the plurality of inferred descriptor lists and obtaining one of the plurality of advertisement categories; d12) respectively calculating secondary category relevance confidences between the advertisement category and each of the descriptors in the selected inferred descriptor list based on a predefined weight and the plurality of descriptor relevance confidences in the selected inferred descriptor list; d13) weighting and calculating the category relevance confidence between the advertisement category and the inferred descriptor list selected based on the plurality of secondary category relevance confidences; and d14) before all of the category relevance confidences of the plurality of advertisement categories are calculated completely, obtaining a next one of the advertisement categories for again executing Step d12 and Step d13.

The above mentioned Step e may further include the following steps:

e1) obtaining a public behavior model; and e2) calculating a plurality of audience response prediction lists based on the public behavior model and the plurality of advertisement category recommendation lists, wherein a quantity of the plurality of audience response prediction lists is identical to a quantity of the plurality of advertisement category recommendation lists, and each of the audience response prediction lists is respectively recorded with the predicted audience response values of the plurality of advertisement categories in each of the advertisement category recommendation lists; wherein, Step f is to analyze one or multiple time sequences as the dotting placement based on the plurality of advertisement category recommendation lists, the dotting model and the plurality of audience response prediction lists.

The public behavior model is recorded with an analytical statistics data of at least one of a click-through rate, a visual retention time, a preference and a conversion rate of each of the advertisement categories for a general user.

The Step e mentioned above may further include a step of: e0) obtaining an individual audience behavior model, wherein the individual audience behavior model is recorded with an analytical statistics data of at least one of a click-through rate, a visual retention time, a preference and a conversion rate of each of the advertisement categories for a specific user; wherein, Step e2 is to calculate and generate the plurality of audience response prediction lists based on the public behavior model, the individual audience behavior model and the plurality of advertisement category recommendation lists jointly.

The step f mentioned above is to analyze one or multiple of the time sequences as the dotting placement of the video based on the plurality of advertisement category recommendation lists, the dotting model, the plurality of audience response prediction list and a dotting placement limiting criteria.

The analysis method may further include the following steps: h) performing a dotting action on the video based on the dotting placement; and i) listing the plurality of advertisement categories corresponding to the dotting placement, the category relevance confidences between each of the advertisement categories and the dotting placement, and the predicted audience response value of each of the advertisement categories.

To achieve the mentioned purpose, the present disclosure further provides a video dotting placement analysis system, including: a video conversion module, configured to select and convert a content of a video into a plurality of descriptor lists, wherein each of the descriptor lists is respectively recorded with a time sequence and a plurality of raw descriptors, and the plurality of raw descriptors are used for describing a plurality of features appeared in the time sequence of the video; an advertisement category analysis module, configured to obtain an advertisement category model recorded with a plurality of advertisement categories, and configured to perform analysis based on the advertisement category model and the plurality of descriptor lists in order to generate a plurality of advertisement category recommendation lists, wherein a quantity of the plurality of advertisement category recommendation lists is identical to a quantity of the plurality of descriptor lists, and each of the advertisement category recommendation lists is respectively recorded with category relevance confidences between each of the plurality of advertisement categories and the content of the video corresponding to each of the time sequence; an audience response prediction module, configured to respectively calculate predicted audience response values of each of the advertisement categories; and a dotting module, configured to analyze one or a plurality of the time sequences as a dotting placement of the video based on the plurality of advertisement category recommendation lists, the plurality of predicted audience response values and a dotting model.

The system mentioned about may further include a descriptor relationship learning module, configured to train and generate a descriptor semantic model based on a plurality of datasets, wherein the descriptor semantic model is formed by a plurality of base descriptors and a plurality of edges with a direction, each base descriptors respectively corresponds to a predefined feature, the plurality of edges define relational strengths among the plurality of base descriptors, and the plurality of base descriptors include the plurality of raw descriptors and the plurality of advertisement categories; an advertisement category learning model, configured to train and generate the advertisement category model, wherein the advertisement category model is recorded with a plurality of base descriptors comprising the plurality of advertisement categories therein; the advertisement category learning model is configured to import the plurality of datasets in order to allow the advertisement category model to learn relevance strengths of each of the advertisement categories corresponding to an individual or a combination of the descriptors; and a descriptor inference module, configured to calculate and generate a plurality of inferred descriptor lists based on the plurality of descriptor lists and the descriptor semantic model, wherein each of the inferred descriptor lists is respectively recorded with the plurality of raw descriptors, a plurality of inferred descriptors and the time sequence corresponding to each of the descriptor lists; wherein the advertisement category analysis module is configured to perform analysis based on the plurality of advertisement categories and the plurality of inferred descriptor lists in order to generate the plurality of advertisement category recommendation lists.

The advertisement category analysis module of the system disclosed above may be configured to perform the following actions in order to generate the plurality of advertisement category recommendation lists:

Action 1: selecting one of the plurality of inferred descriptor lists and performing matching with the plurality of advertisement categories in the advertisement category model in order to respectively calculate the category relevance confidences between the plurality of advertisement categories and the video content corresponding to the selected inferred descriptor list;

Action 2: determining whether all of the plurality of inferred descriptor lists are matched completely; and

Action 3: before all of the plurality of inferred descriptor lists are matched completely, selecting next inferred descriptor list from the plurality of inferred descriptor lists for executing the Action 1 again.

The Action 1 performed by the advertisement category analysis module may further include the following actions:

Action 1-1: selecting one of the plurality of inferred descriptor lists and obtaining one of the plurality of advertisement categories;

Action 1-2: calculating respective secondary category relevance confidences between the secondary advertisement category and each descriptor in the selected inferred descriptor list based on a predefined weight and a plurality of the descriptor relevance confidences in the selected inferred descriptor list;

Action 1-3: weighting and calculating the category relevance confidence between the advertisement category and the selected inferred descriptor list based on the plurality of the secondary category relevance confidences; and

Action 1-4: before all of the category relevance confidences of the plurality of advertisement categories are calculated completely, obtaining a next one of the advertisement categories for executing the Action 1-2 and the Action 1-3 again.

The audience response prediction module of the analysis system mentioned above may be configured to obtain a pubic behavior model as well as calculating and generating a plurality of audience response prediction lists based on the public behavior model and the plurality of advertisement category recommendation lists, wherein a quantity of the plurality of audience response prediction lists is identical to a quantity of the plurality of advertisement category recommendation lists, and each of the audience response prediction list is respectively recorded with the predicted audience response values of the plurality of advertisement categories in each of the advertisement category recommendation lists; wherein the dotting module is configured to analyze one or multiple of the time sequences as the dotting placement of the video based on the plurality of advertisement category recommendation lists, the dotting model and the plurality of audience response prediction lists; and wherein the public behavior model is recorded with an analytical statistics data of at least one of a click-through rate, a visual retention time, a preference and a conversion rate of each of the advertisement categories for a general user.

The audience response prediction module of the analysis system disclosed above may further be configured to obtain an individual audience behavior model as well as calculating and generating the plurality of audience response prediction lists based on the public behavior model, the individual audience behavior model and the plurality of advertisement category recommendation lists jointly, wherein the individual audience behavior model is recorded with an analytical statistics data of at least one of a click-through rate, a visual retention time, a preference and a conversion rate of each of the advertisement categories for a specific user.

The dotting module of the analysis system disclosed above may be configured to analyze one or multiple of the time sequences as the dotting placement of the video based on the plurality of advertisement category recommendation lists, the dotting model, the plurality of audience response prediction lists and a dotting placement limiting criteria.

The dotting module of the analysis system disclosed above may be configured to perform a dotting action on the video based on the dotting placement, and may be configured to list the plurality of advertisement categories corresponding to the dotting placement, the category relevance confidences between each of the advertisement categories and the dotting placement, and the predicted audience response values of each of the advertisement categories.

To achieve the mentioned purpose, the present disclosure provides a computer-readable medium having a program stored therein, wherein the program is configured to perform operations described above when the program is executed by a processing unit.

Comparing to the known art, the present disclosure may analyze a video automatically to find multiple dotting placements from the video and recommend the advertisement categories that are highly relevant to the content of the dotted placement within the video, and each dotted placement is relatively having the highest predicted AR value. Thus, the cost effectiveness of advertising is optimized by adopting automated approach and objective analysis standards for finding the dotting placement are provided for the advertising industry.

### BRIEF DESCRIPTION OF DRAWING

FIG. 1 shows a schematic diagram of analysis system according to a first embodiment of the present disclosure.

FIG. 2A shows an illustration of the descriptor list according to the first embodiment of the present disclosure.

FIG. 2B shows an illustration of the ADC model according to the first embodiment of the present disclosure.

FIG. 3 shows a flowchart of a video dotting placement analysis according to a first embodiment of the present disclosure.

FIG. 4A shows a flowchart of first analysis for dotting placements according to the second embodiment of the present disclosure.

FIG. 4B shows a flowchart of second analysis for dotting placements according to the second embodiment of the present disclosure.

FIG. 5 shows an illustration of the descriptor semantic model according to the first embodiment of the present disclosure.

FIG. 6 shows a schematic view of the generation of the inferred descriptor list according to the embodiments of the present disclosure.

FIG. 7 shows a schematic view of the generation of the ADC recommendation list according to the first embodiment of the present disclosure.

FIG. 8 shows a schematic view of the generation of the AR prediction list according to the first embodiment of the present disclosure.

FIG. 9 shows a schematic view of the dotting placement according to the first embodiment of the present disclosure.

FIG. 10 shows a schematic view of the analysis system according to the second embodiment of the present disclosure.

FIG. 11 shows a video playing flowchart according to the first embodiment of the present disclosure.

FIG. 12 shows a dotting placement bidding flowchart according to the first embodiment of the present disclosure.

FIG. 13 shows a schematic view of an analysis system according to a third embedment of the present disclosure

### DETAILED DESCRIPTION OF THE INVENTION

Embodiments of the present disclosure will now be described, by way of example only, with reference to the accompanying drawings.

The present disclosure is about a video dotting analysis system (abbreviates as “analysis system” hereinafter). The analysis system analyzes an imported video to find one or a plurality of dotting placements within the imported video that have a relatively high advertising effect and recommends one of a plurality of advertisement categories that have a relatively high relevance to video content (or video frames) of the corresponding dotted placements.

By implementing the present disclosure, the advertiser may select the creatives in the advertisement categories recommended by the analysis system and insert the creatives at said placements of the video. On the priority of ensuring the contents of the video and the creative are highly relevant, the advertising effect is maximized (e.g. effects like having a high click-through rate (CTR), conversion rate (CVR), retention time, reach percentage or raising the engagement percentage of the promoted product).

The dotting placement in the present disclosure includes a time spot or a time section and is not limited thereto. Specifically, the time spot is a specific point of time in a video (e.g. 01:35) for inserting a linear creative (e.g. the video is paused while the inserted creative is playing). The time section is a section of time in the video (e.g. 01:30˜01:40) for inserting a non-linear creative (e.g. the video is playing while the overlay ad is also playing).

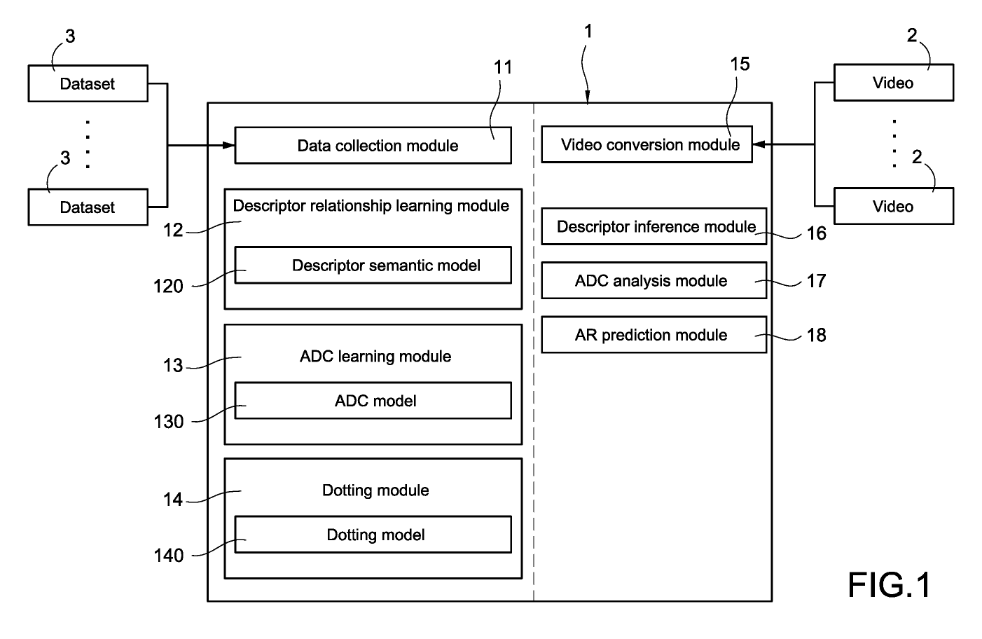

Referring to FIG. 1, a schematic diagram of analysis system according to a first embodiment of the present disclosure is shown. In order to help ordinary artisans of the art to understand the present disclosure, descriptors (or tags) will be used to represent the significant features of a video but the format is not limited to such.

In the embodiment shown in FIG. 1, the analysis system 1 of the present disclosure may at least include a data collection module 11, a descriptor relationship learning module 12, an advertisement category (ADC) learning module 13, a dotting module 14, a video conversion module 15, a descriptor inference module 16, an ADC analysis module 17 and an audience response (AR) prediction module 18.

In one of the embodiments, the analysis system 1 may be a server (e.g. a local server or a cloud server) and said modules 11-18 may be the physical units in the server for implementing different functions. In another embodiment, the analysis system 1 may be a single processor or an electronics device. The analysis system 1 may execute specific program instructions to implement the functions and said modules 11-18 may respectively correspond to the functional module of each described function of the program instructions.

The data collection module 11 is connected to the internet. A plurality of dataset 3 is collected by accessing any public data via the internet. Specifically, dataset 3 may be general data such as encyclopedia, text book, or data updated as time revolves such as Wikipedia, internet news or comments (e.g. video comments on YouTube or text comments on Facebook), etc. The dataset 3 may be in forms of text data, image information, video information, or audio data and is not limited thereto.

The data collection module 11 uses Crawler to access the Internet and collects the updated data in real time or in regular time intervals. Further, data from the datasets 3 is inputted to the descriptor relationship learning module 12. And in turn, the descriptor relationship learning module 12 analyzes the data to train and output the DSM 120.

The video conversion module 15 is for receiving or selecting a video 2 to be analyzed and converting the content of the video 2 into a plurality of descriptor list with temporal information.

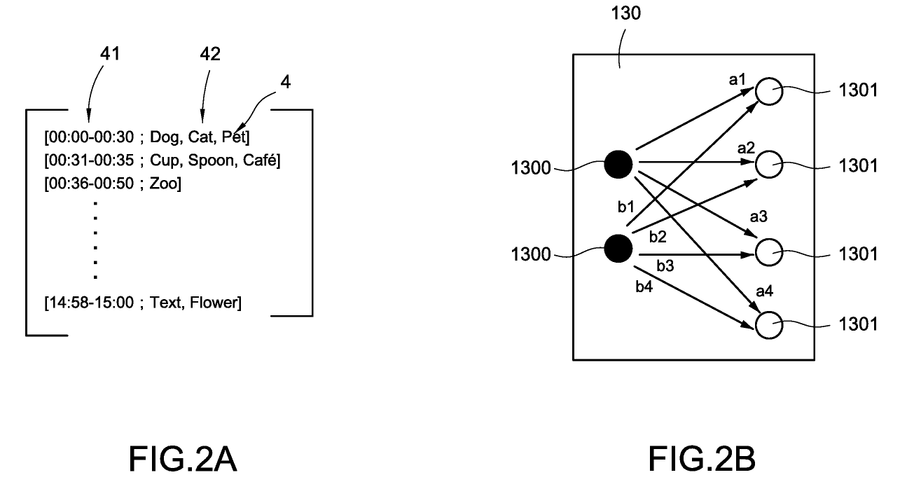

Referring to FIG. 2A, an illustration of the descriptor list according to the first embodiment of the present disclosure is shown. The video conversion module 15 splits up the video 2 to generate a plurality of sets of shots and generates a respective descriptor list 4 for each set of shots. In the embodiment, each descriptor list records a time sequence 41 and the corresponded raw descriptor 42 respectively, wherein each time sequence 41 is corresponded to the time (such as the spot of time or section of time) of the said shots and the raw descriptors describe the significant features appeared within the time sequence 41 (i.e. the images correspond to time sequence 41) of the video 2.

In one of the embodiments, the video conversion module 15 mainly identifies and not limit to face, image, text, audio, action, object and scene as the significant features; and generates the raw descriptors according to the identified significant features. In other words, if the video conversion module 15 identifies 1000 features in a set of shots, 1000 corresponding raw descriptor 42 will be generated.

Specifically, the video conversion module 15 is able to perform slicing of the video 2 according to the default time granularity. In an exemplary embodiment, the time granularity refers to the time sequence 41.

In a first embodiment, the video conversion module 15 is able to perform splitting up the video 2 according to the default temporal unit (such as one second, three seconds, ten seconds etc.) in order to generate multiple sets of shots. Accordingly, the sets of shots have the same time length. In a second embodiment, the video conversion module 15 detects the scene changes in the video 2 and performs splitting up the video 2 based on the scene changes in order to generate multiple sets of shots (i.e. one set of shots corresponds to one scene). Accordingly, the sets of shots are in different time length. The aforementioned technique of detecting the scene change belongs to the well-known art in the field; therefore, details thereof are omitted. In a third embodiment, the video conversion module 15 is able to perform splitting up the video 2 based on the unit of “frames” in order to generate multiple sets of shots (i.e. the length of each set of the shots is one frame). Therefore, the sets of shots have a unified time length.

Please refer to FIG. 1 and FIG. 2B. FIG. 2B shows an illustration of the ADC model according to the first embodiment of the present disclosure. In an exemplary embodiment, the analysis system 1 is able to use the ADC learning module 13 to pre-train and establish an ADC model 130, or the ADC model 130 may be established during the time when the analysis system 1 performs analysis on the video 2; and the present disclosure is not limited to specific configurations.

The ADC model 130 mainly records the relationships among a plurality of ADCs 1300 and a plurality of descriptors 1301. As shown in FIG. 2B, the ADC model 130 may be recorded with a plurality of descriptors 1301, such as several millions of descriptors, each descriptor 1301 is defined with a different feature respectively, and such descriptors 1301 also include features corresponding to a plurality of ADCs 1300. There are four descriptors 1301 illustrated in FIG. 2B as an example but is not limited thereto.

The ADC learning module 13 may perform training on the ADC model 130 with the imported data (such as the dataset 3) in order to allow the ADC model 130 to learn the linking strength (such as a1-a4 and b1-b4 in FIG. 2B) of each descriptor 1301 or combinations of a plurality of descriptors 1301 relative to each ADC 1300.

According to the above, after the training of the ADC model 130 is completed, the analysis system 1 is able to import an unknown creative into the ADC model 130 in order to analyze how the creative should be classified into one or ones of ADC 1300 that are suitable for the creative based on the content thereof (i.e. the descriptors contained in the creative).

In another exemplary embodiment, the analysis system 1 may further connect to one or a plurality of advertisement databases (not shown in the drawings). The advertisement database has already stored with the creatives of all types of known ADCs (such as four hundred ADCs, one thousand ADCs etc.). The ADC learning module 13 is able to analyze the relationships among the contents of a plurality of creatives and a plurality of ADCs 1300 in order to establish the ADC model 130. Furthermore, different advertisers may have different definitions for ADCs. Therefore, the ADC learning module 13 is able to train individual ADC model 130 based on the advertisement database of different advertisers. Moreover, the plurality of ADCs 1300 may further be classified into categories with a hierarchical structure. For example, a primary category (such as: the category of “travel”) with subsidiary categories (such as the categories of “China” and “US”). The number of hierarchical levels is not limited thereto.

The ADC analysis module 17 obtains the ADC model 130 and performs analysis based on the ADC model 130 and the plurality of descriptor lists 4 of the video in order to generate a plurality of ADC recommendation lists. In an exemplary embodiment, the quantity of the plurality of ADC recommendation lists is identical to the quantity of the plurality of descriptor lists 4. In other words, the ADC analysis module 17 generates a corresponding ADC recommendation list for each set of shots split up by the video conversion module 15.

In an exemplary embodiment, each ADC recommendation list is recorded with a category relevance confidence of each ADC 1300 and the corresponding video content of each time sequence 41 (i.e. each set of shots) respectively. For example, if a high category relevance confidence of the first set of shots is obtained with a first ADC, it means the first ADC and the content of the first set of shots are highly related, and thus the first set of shots is determined by the analysis system 1 to be a dotting placement with economic benefit, then the analysis system 1 may further recommend the advertiser to insert the creative of the first ADC into the first set of shots.

The AR prediction module 18 is used for calculating the predicted AR values of each ADC 1300, predicting audience response values such as viewing rate, liking rate, click-through rate or conversion rate and is not limited thereof for a general audience or a specific audience after the creatives of each ADC 1300 are being inserted into each shot. In an exemplary embodiment, the analysis system 1 is able to use the predicted AR value as one of the criteria for determining the dotting placement.

The dotting module 14 is able to pre-train a dotting model 140. Specifically, the dotting module 14 is able to use crawler in real-time or periodically crawling the internet in order to collect videos that have already have the advertisement placement marked (including automatic and manual dotted videos from platforms such as YouTube, QQ, Baidu etc.), or to collect the existing advertisement video statistical database (such as the database recorded the click-through rate data of advertisements in videos on the network). Furthermore, the administrator of the analysis system 1 may also purchase the video statistics data from all major Data Management Platform (DMP) operators in order to import and train the dotting module 14.

In view of the above, the dotting module 14 is able to analyze the relationships among different video contents (equivalent to the descriptors of the present disclosure), the dotting placements of videos, ADC, advertisement contents and advertisement AR values (such as the click-through rate etc.) based on the aforementioned data in order to train the dotting model 140 accordingly. In general, after the dotting model 140 is trained completely, at least the relationship among the video content, ADC and the dotting placement can be recorded.

In an exemplary embodiment of the present disclosure, the dotting module 14 is able to perform analysis according to the plurality of ADC recommendation lists, the plurality of predicted AR values and the dotting model 140 in order for one or a plurality of time sequences 14 (i.e. one or a plurality sets of shots of the video 2) to be determined as the one or a plurality of dotting placements of the video 2.

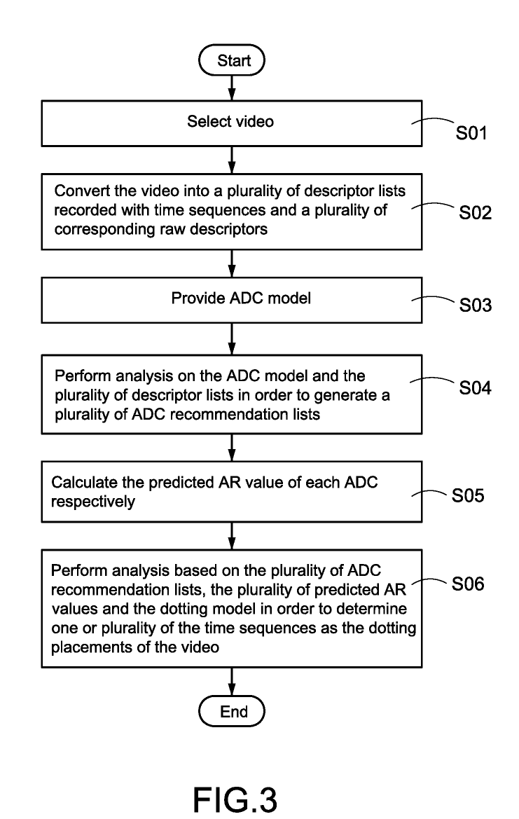

Please refer to FIG. 1 and FIG. 3. FIG. 3 refers to a dotting placement analysis flowchart according to the first embodiment of the present disclosure. The present disclosure further discloses a video dotting placement analysis method (hereinafter referred to as the “analysis method”), and the analysis method is applicable to the analysis system 1 as shown in FIG. 1 in order to allow the analysis system 1 to analyze where to do dotting on a video 2.

As shown in FIG. 3, when a dotting action is to be performed on video 2, the video 2 is being inputted into the analysis system 1 first (Step S01). The video conversion module 15 then converts the video 2 into a plurality of descriptor lists 4 containing the aforementioned time sequences 41 and the corresponding plurality of raw descriptors 42 (Step S02).

Next, the analysis system 1 provides or generates the aforementioned ADC model 130 (Step S03). In addition, the ADC analysis module 17 uses the ADC model 130 to perform analysis on the plurality of descriptor lists 4 in order to generate the plurality of ADC recommendation lists (Step S04).

Following the above, the analysis system 1 uses the AR prediction module 18 to calculate the predicted AR value of each ADC 1300 respectively (Step S05).

In an exemplary embodiment, after the ADC model 130 is established completely, the analysis system 1 then use the AR prediction module 18 to calculate the predicted AR value of each ADC 1300 in the ADC model 130 and re-calculate the predicted AR value periodically based on the data collected by the crawler on the network. In another exemplary embodiment, during the analysis of the dotting placement of the video 2, the analysis system 1 may further use the AR prediction module 18 to calculate the predicted AR value of each ADC 1300 in real-time.

Lastly, the analysis system 1 uses the dotting module 14 to perform analysis according to the plurality of ADC recommendation lists, the plurality of predicted AR values and the dotting model 140 in order to determine the one or plurality of time sequences 41 (i.e. one or a plurality sets of shots of the video 2) of the video 2 to be the one or a plurality of dotting placements of the video 2 (Step S06).

Through the analysis system 1 and the analysis method of the present disclosure, the administrator is able to understand which placements are the dotting placements with greater advertising effect for a video 2, and also understand which advertisements under which ADCs are suitable for each dotting placements.

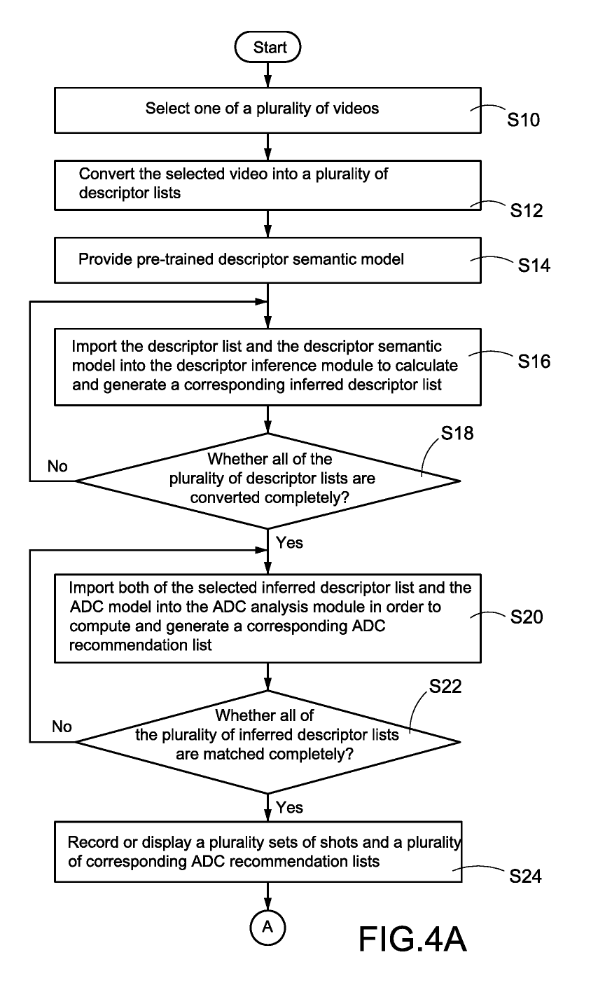

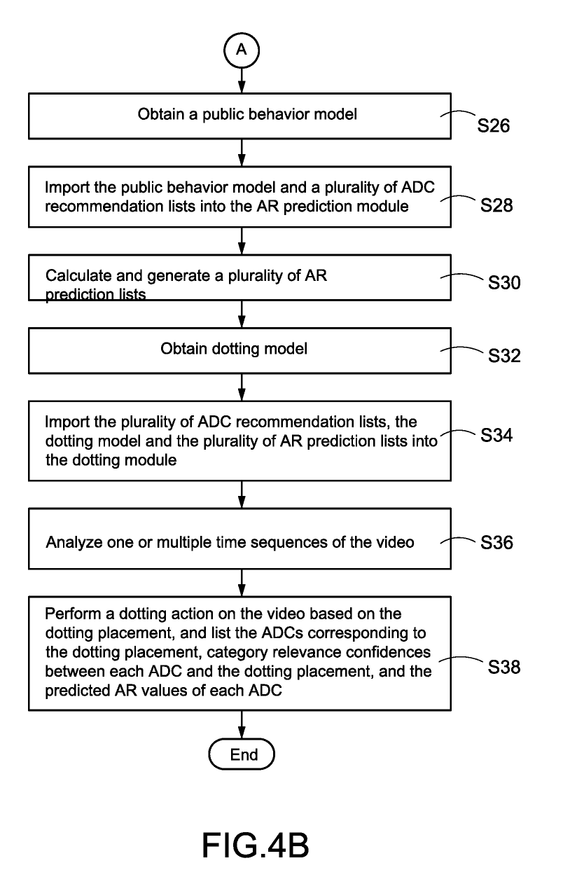

Please refer to FIG. 4A and FIG. 4B, showing a first analysis flowchart and a second analysis flow chart for dotting placements according to the second embodiment of the present disclosure. In addition, FIG. 4A and FIG. 4B can be used to further illustrate each step of the analysis method shown in FIG. 3 in greater detail.

First, the analysis system 1 provides or selects one of a plurality of videos 2 (Step S10). Next, the video conversion module 15 converts the selected video 2 into the plurality of descriptor lists 4 (Step S12). Then, the analysis system 1 further provides a pre-trained descriptor semantic model 120 (Step S14).

Specifically, the descriptor relationship learning module 12 uses the plurality of datasets 3 collected by the data collection module 11 for pre-training then generates the descriptor semantic model 120.

In an exemplary embodiment, the descriptor relationship learning module 12 uses deep learning/artificial intelligence to analyze the aforementioned datasets 3 in order to obtain the relationships among the features of texts, images, videos and a plurality of predefined descriptors. Furthermore, the descriptor relationship learning module 12 extracts the core meaning of the aforementioned descriptors, then performs offline computation using at least one of the Hidden Markov Model algorithms to train the descriptor semantic model 120. The purpose of extracting the core meaning is to unify the descriptors; for example, the descriptor relationship learning module 12 can filter out a multiple/single number of quantitative terms (such as, book and books both have the meaning of “book”; happy and happiness both have the meaning of “happy”).

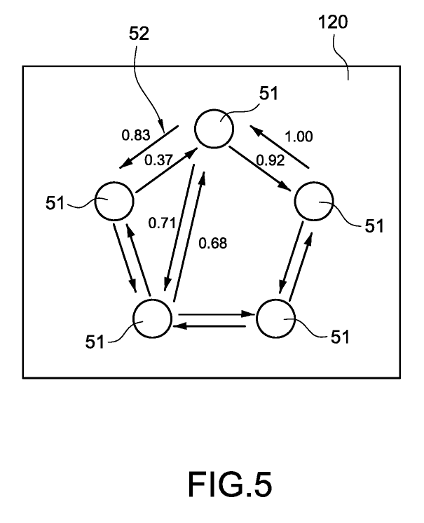

Please refer to FIG. 5, showing an illustration of the descriptor semantic model according to the first embodiment of the present disclosure. As shown in FIG. 5, the structure of descriptor semantic model 120 is mainly formed by a plurality of base descriptors 51 and a plurality of directed edges 52, whereas each base descriptor 51 corresponds to one predefined feature (such as the aforementioned book, happy etc.) respectively and each edge 52 defines the relational strength between the base descriptors 51 at its ends.

In an exemplary embodiment, the quantity of the base descriptors 51 can be thousands or tens of thousands, and the base descriptors 51 also include and are not limited to various types of features, such as people, objects, actions, emotions, atmosphere, titles, categories etc. The edges 52 respectively define the relational strengths among the features (such as the relational strength between “Trump” and “President”, the relational strength between ‘eat” and “happy”, the relational strength between “beach” and “travel” etc.). It shall be noted that the aforementioned plurality of base descriptors 51 include the aforementioned plurality of raw descriptors 42 and the plurality of ADCs 1300 (in the present disclosure, the analysis system 1 treats each ADC 1300 as a descriptor respectively).

According to the above, after Step S14, the analysis system 1 further obtains one of the plurality of descriptor lists 4, such as the first descriptor list, and then imports the first descriptor list and the descriptor semantic model 120 into the descriptor inference module 16 to calculate and generate a corresponding inferred descriptor list (Step S16). The inferred descriptor list is recorded with a part of the base descriptors 51 in the descriptor semantic model 120 (i.e. the raw descriptors 42 that were imported into the descriptor semantic model 120) and the inferred descriptors that were inferred (not shown in the drawings).

In an exemplary embodiment, after Step S16, the analysis system 1 determines whether all of the plurality of descriptor lists 4 have been converted into the inferred descriptor list (Step S18), and obtains the next descriptor list 4 (such as the second descriptor list) for executing step S16 until all of the descriptor lists 4 have been converted completely. In other words, Step S16 and Step S18 are performed to convert the plurality of descriptor lists 4 generated by the video conversion module 15 into a plurality of inferred descriptor lists of the same quantity.

Specifically, the video conversion module 15 is able to convert video 2 into descriptor lists 4 containing time sequences 41 and plurality of raw descriptors 42; however, the video conversion module 15 cannot identify the extended information in the video 2 directly (for example, it cannot obtain the descriptor of “President” after identifying “Trump”, or it cannot obtain the descriptor of “danger” or “tension” after identifying a person pointing a gun at another person). The aforementioned descriptor semantic model 120 in the present disclosure is used to process each of the descriptor lists 4 to infer additional inferred descriptors from the plurality of raw descriptors 42 in the descriptor lists 4 and the relationship between each descriptor (including the raw descriptor 42 and the inferred descriptor) and their corresponding time sequences 41 (i.e. the corresponding shot).

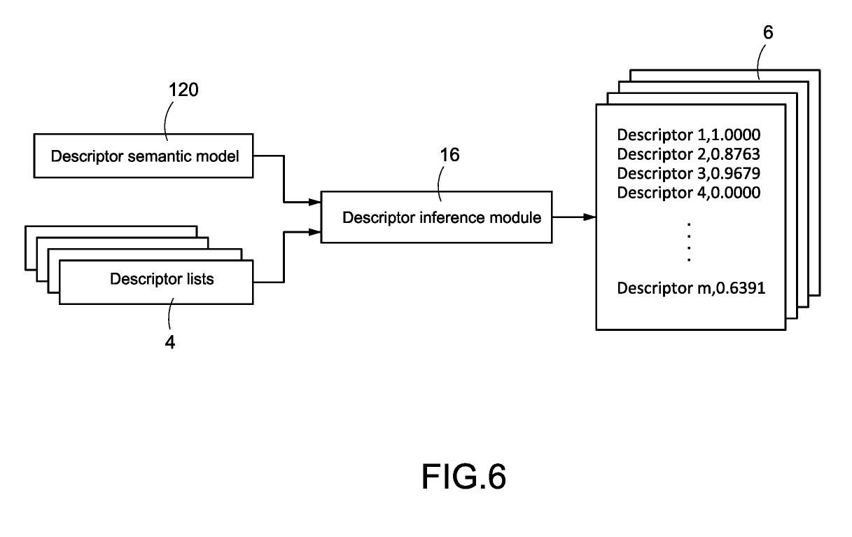

Please refer to FIG. 6, showing a schematic view of the generation of the inferred descriptor list according to the first embodiment of the present disclosure. As shown in FIG. 6, the analysis system 1 imports the descriptor semantic model 120 and the plurality of descriptor lists 4 into the descriptor inference module 16 in order to allow the descriptor inference module 16 to calculate and generate a plurality of corresponding inferred descriptor lists 6. In addition, each inferred descriptor list 6 is recorded with a plurality of descriptors (including a plurality of raw descriptors 42 and a plurality of inferred descriptors) as well as the relationship between each descriptor and the corresponding time sequence 41.

In other words, the quantity of the plurality of inferred descriptor lists 6 is equivalent to the quantity of the plurality of descriptor lists 4. If the video conversion module 15 splits the video 2 into ten sets of shots, then ten descriptor lists 4 are generated, and the descriptor inference module 16 is able to convert the ten descriptor lists 4 into ten inferred descriptor lists 6. Moreover, the quantity of the descriptors in each inferred descriptor list 6 is identical to the quantity (the number of “m” in FIG. 6 is used as an example) of the base descriptors 51 in the descriptor semantic model 120.

For example, if the descriptor semantic model 120 includes thirty thousand base descriptors 51 and the first descriptor list includes seven thousand raw descriptors 42, then the descriptor inference module 16 is able to generate twenty-three thousand inferred descriptors from the first descriptor list after the process and to compute the respective confidences of the seven thousand raw descriptors 42 and the twenty-three thousand inferred descriptors that are corresponded to the time sequence of the first descriptor list of the shots of the video 2. In the exemplary embodiment as shown in FIG. 6, for example, the confidences may be in a range from 0.0000 to 1.0000 and is not limited thereto.

It shall be noted that the quantity of the descriptors in the inferred descriptor list 6 is greater than the quantity of the raw descriptors 42 in each of the descriptor list 4; therefore, a part of the inferred descriptors in the inferred descriptor list 6 may be completely irrelevant to the content that is corresponded to the time sequence 41 of each of the descriptor list 4. Under such condition, the confidence of such descriptor may be 0.0000.

Please refer to FIG. 4A again. After Step S18, the analysis system 1 selects one of the plurality of inferred descriptor lists 6 generated and imports both of the selected inferred descriptor list 6 and the ADC model 130 into the ADC analysis model 17 in order to use the ADC analysis model 17 to compute and generate a corresponding ADC recommendation list (Step S20).

Specifically, in Step S20, the ADC analysis model 17 mainly matches the selected inferred descriptor list 6 with the plurality of ADCs 1300 of the ADC model 130 in order to compute the respective category relevance confidence between each ACD 1300 and the shot of the video 2 that is corresponded to the selected inferred descriptor list 6.

In the aforementioned Step S04 of the embodiment shown in FIG. 3, the ADC analysis model 17 matches each of the plurality of ADCs 1300 in the ADC model 130 with the plurality of raw descriptors 42 in a descriptor list 4 (such as the first descriptor list) respectively in order to determine the category relevance confidence between each ADC 1300 and the shot of the video 2 that is corresponded to the first descriptor list.

In Step S20 of the exemplary embodiment as shown in FIG. 4A, the ADC analysis module 17 matches the plurality of ADCs 1300 in the ADC model 130 with the plurality of descriptors (including a plurality of raw descriptors and a plurality of inferred descriptors) in a inferred descriptor list 6 (such as the first inferred descriptor list) in order to determine the relevance confidence between each ADC 1300 and the shot of the video 2 that is corresponded to the first inferred descriptor list. In an exemplary embodiment, the number of descriptors included in the inferred descriptor list 6 is greater than the number of descriptors included in the descriptor list 4; therefore, the category relevance confidence computed in Step S20 is more precise than the category relevance confidence computed in Step S04 shown in FIG. 3.

After Step S20, the ADC analysis module 17 determines whether the plurality of inferred descriptor lists 6 are matched completely with all of the ADCs 1300 (Step S22), and selects the next inferred descriptor list 6 (such as the second inferred descriptor list) again to execute step S20 until all of the plurality of inferred descriptor lists are matched. In other words, Step S20 and Step S22 are executed to generate a plurality of ADC recommendation lists 7 having a quantity that is identical to the quantity of the plurality of inferred descriptor lists 6.

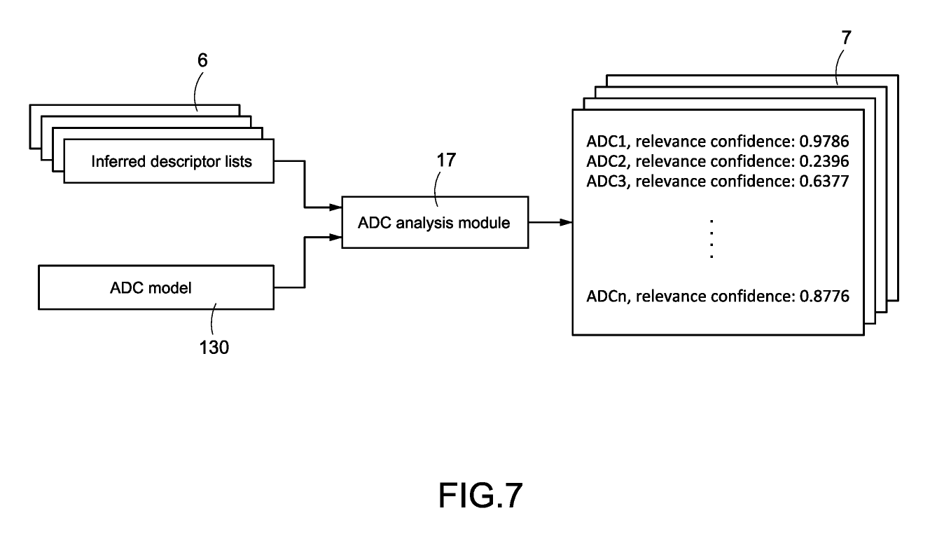

Please refer to FIG. 7, showing a schematic view of the generation of the ADC recommendation list according to a first embodiment of the present disclosure. As shown in FIG. 7, after the analysis system 1 imports the ADC model 130 and a plurality of inferred descriptor lists 6 into the ADC analysis module 17, the ADC analysis module 17 then calculates and generates a plurality of ADC recommendation lists 7. In addition, each ADC recommendation list 7 is recorded with the plurality of ADCs 1300 in the ADC model 130 respectively as well as the category relevance confidence between each ADC 1300 and the video content corresponding to each inferred descriptor list 6.

It shall be noted that the quantity of the plurality of ADC recommendation lists 7 is the same as the quantity of the plurality of inferred descriptor lists 6, and the plurality of ADCs 1300 recorded in each ADC recommendation list 7 are completely identical to the plurality of ADCs 1300 (“n” number of ADC is used as an example in FIG. 7) in the ADC model 130.

For example, if the quantity of the inferred descriptor lists 6 is ten (i.e. corresponding to 10 sets of shots of the video 2) and the ADC model 130 records four hundred ADCs 1300, then the ADC analysis module 17 generates ten ADC recommendation lists 7 (corresponding to the ten sets of shots) after computation, each ADC recommendation list 7 records the four hundred ADCs 1300 and the relevance confidence for each ADC 1300 and the shot of the video 2 corresponded to the inferred descriptor list 6.

Specifically, in an exemplary embodiment, the ADC analysis module 17 mainly executes the following actions in the aforementioned Step S20 in order to generate an ADC recommendation list 7:

First, the ADC analysis module 17 selects one of the inferred descriptor lists 6 (such as selecting the first inferred descriptor list) and obtains one of the plurality of ADCs 1300 (such as obtaining the first ADC).

Next, the ADC analysis module 17 respectively calculates secondary category relevance confidences of the first ADC with each descriptor in the first inferred descriptor list according to a predefined weight and a plurality of descriptor relevance confidences of the first inferred descriptor list (i.e. if the first inferred descriptor list includes thirty thousand descriptors, then the ADC analysis module 17 generates thirty thousand secondary category relevance confidences for the first ADC).

Then, ADC analysis module 17 computes the weights according to the plurality of secondary category relevance confidences to obtain the category relevance confidence of the first ADC for the first inferred descriptor list. In other words, the aforementioned category relevance confidence refers to a weighting sum of the plurality of secondary category relevance confidences.

In addition, the ADC analysis model 17 obtains the next ADC (such as the second ADC) for performing the above action repeatedly before the category relevance confidences of all of the ADCs 1300 in the ADC model 130 are calculated completely. After the category relevance confidences of all of the ADC 1300s in the ADC model 130 for the first inferred descriptor list are computed completely, the ADC analysis module 17 then generates an ADC recommendation list 7 corresponding to the first inferred descriptor list based on the category relevance confidences for all of the ADCs 1300.

Next, through the execution of the aforementioned step S22, the ADC analysis module 17 may continuously compute and generate another ADC recommendation list 7 corresponding to other inferred descriptor list 6.

Please refer to FIG. 4A again. After Step S22, the analysis system 1 has already generated a corresponding ADC recommendation list 7 for each set of shots that were split up from the video 2, and each ADC recommendation list 7 is recorded with the category relevance confidence of each ADC 1300 with each set of shots. Therefore, in an exemplary embodiment, the analysis system 1 is able to record the plurality sets of shots and the corresponding plurality of ADC recommendation lists 7 selectively, or to display the plurality sets of shots and the plurality of corresponding ADC recommendation lists 7 on a display interface (not shown in the drawings) (Step S24).

In an exemplary embodiment, the analysis system 1 is able to perform sequential arrangement on each ADC 1300 in each ADC recommendation list 7 based on the category relevance confidences and may provide top-K number of ADCs 1300 or provide one or a plurality of ADCs 1300 having category relevance confidence higher than a threshold value. Accordingly, the ADCs having low relevance with each set of shot of the video 2 may be filtered in advance in order to reduce the subsequent work load of the analysis system 1.

Furthermore, as shown in FIG. 4B, during the calculation of the predicted AR value, the analysis system 1 obtains a public behavior model first (Step S26), and respectively imports the public behavior model and the plurality of ADC recommendation lists 7 into the AR prediction module 18 (Step S28) so the AR prediction module 18 calculates a plurality of AR prediction lists (Step S30).

In an exemplary embodiment, the public behavior model is recorded with the information of analytical statistics data of the click-through rate, visual retention time, preference, conversion rate (CVR) etc. of the general public on each ADC 1300. Specifically, the AR prediction module 18 is able to use the crawler to collect relevant advertisement information of each video on the network in real-time or periodically, or to collect existing advertisement video statistics databases, such as the data of click-through rate of advertisements in the video on the network. Furthermore, the administrator of the analysis system 1 can also purchase the AR data from all major DMP operators directly and imports such data into the AR prediction module 18.

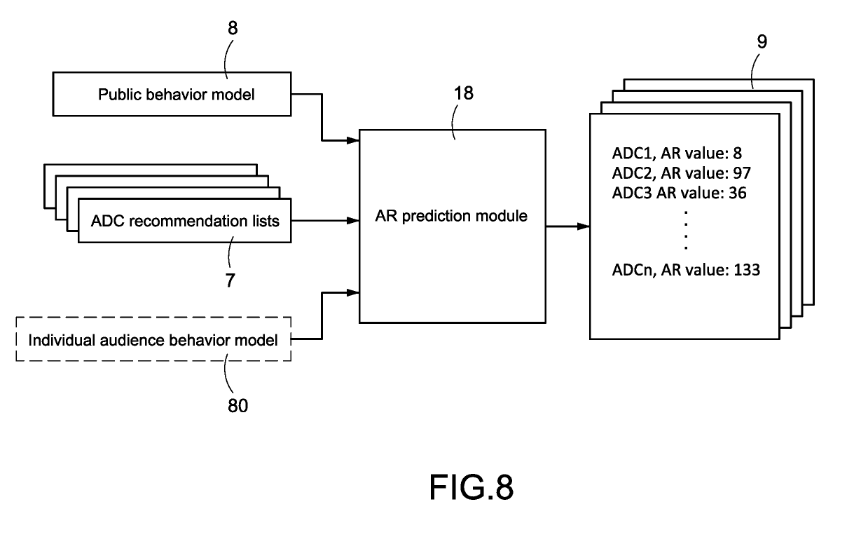

Please refer to FIG. 8, showing a schematic view of the generation of the AR prediction list according to the first embodiment of the present disclosure. As shown in FIG. 8, after the analysis system 1 imports a public behavior model 8 and a plurality of ADC recommendation lists 7 into the AR prediction module 18, the AR prediction module 18 is able to calculate and generate a plurality of AR prediction lists 9. In addition, each AR prediction list 9 is recorded with the plurality of ADCs 1300 and the respective predicted AR values for each ADC 1300 upon the corresponding shot of the video 2.

The quantity of the plurality of AR prediction lists 9 is identical to the quantity of the plurality of ADC recommendation lists, and the plurality of ADCs 1300 in each AR prediction list 9 is completely identical to the plurality of ADCs 1300 (“n” number of ADCs is used as an example in FIG. 8) recorded in each ADC recommendation list 7. In other words, if the video conversion module 15 splits the video 2 into ten sets of shots, then the AR prediction module 18 generates ten AR prediction lists 9 and each AR prediction list 9 corresponds to a set of shot respectively. In addition, if the ADC model 130 records four hundred ADCs 1300, then each AR prediction list 9 respectively records four hundred ADCs 1300 and the predicted AR values of these four hundred ADCs 1300 corresponding to the set of shots of the video 2.

As shown in FIG. 8, the analysis system 1 can further import an individual audience behavior model 80 into the AR prediction module 18; therefore, the AR prediction module 18 is able to compute and generate the plurality of AR prediction lists 9 based on the public behavior model 8, the plurality of ADC recommendation lists 7 and the individual audience behavior model 80 at the same time.

In an exemplary embodiment, the individual audience behavior model 80 records analytical statistics data of click-through rate, visual retention period, preference, conversion rate etc. of each ADC 1300 for a specific audience. The individual audience behavior model 80 may further record the web browsing behavior information such as browser history or on-line shopping website browsing history of the specific audience in order to determine the interest, hobby and consumer habit of the specific audience. Through the use of the individual audience behavior model 80, the dotting placement and the corresponding ADC found by the analysis system 1 and the analysis method of the present disclosure can be closer to the preference of the specific audience such that the personalized advertisement service can be provided precisely.

For example, the individual audience behavior model 80 learned that a user A is a fan of a basketball star B; therefore, when the AR prediction module 18 is calculating the predicted AR values of each type of advertisement category, the predicted AR values of the ADCs related to the basketball start B (such as basketball, sports shoes, sports clothes, game, tickets etc.) would be higher.

In addition, according to the individual audience behavior model 80 that has learned user A has purchased the sports shoes endorsed by basketball player B ten days ago, when the AR prediction module 18 is calculating the predicted AR values of each ADC, it would then further decrease the predicted AR values of the ADCs related to sports shoes. As a result, when the AR prediction module 18 of the present disclosure is predicting the predicted AR values for each ADC, it responds effectively to the individual audience behavior in order to allow the prediction result to be more accurate; consequently, the objective of providing personalized advertisement can be achieved.

Please refer to FIG. 4B again. After Step S30, the analysis system 1 has already obtained the predicted AR values of each ADC 1300 corresponding to each set of shots of the video (i.e. the plurality of AR prediction lists 9). Next, the analysis system 1 obtains the dotting model 140 that has been pre-trained completely by the dotting module 14 (Step 32), and it also imports the plurality of ADC recommendation lists 7, the dotting model 140 and the plurality of AR prediction lists 9 into the dotting module 14 (Step S34) in order to use the dotting module 14 to analyze the plurality of time sequences 14 (i.e. the shots of the video 2 respectively correspond to each time sequence 41) of the video 2 such that one or several time sequences 41 can be regarded as the dotting placement(s) of the video 2 (Step S36).

In an exemplary embodiment, the analysis system 1 may only record the analyzed dotting placements and to provide the record to a video operator, an advertiser or a third party in order to allow the video operator, the advertiser or the third party to perform the actual dotting action on the video 2.

In another exemplary embodiment, the analysis system 1 may perform the dotting action on the video 2 directly based on the dotting placements analyzed and obtained, and it may also list a plurality of ADCs 1300 corresponding to the dotting placements, the category relevance confidences between each ADC 1300 and the dotting placements as well as the predicted AR values of each ADC 1300 (Step S38). Accordingly, when an advertiser is searching the video 2, the advertiser is able to know quickly that whether the advertisements are suitable to be delivered to each dotting placement of the video 2. Furthermore, when a video operator is searching video 2, the video operator is able to learn quickly about which ADC advertisers should be sold to for the dotting placements found.

As previously mentioned, the dotting model 140 has been trained completely in advance and is recorded with the relationships among the video content, the ADCs and the dotting placements. Therefore, the analysis system 1 of the present disclosure is able to analyze the dotting placements of the video 2 based on the plurality of ADC recommendation lists 7, the plurality of AR prediction lists 9 and the dotting model 140 in order to allow the dotting placement found to be of the greatest advertising effect (such as being preferred the most by general audience, better viewing experience, most suited to the needs of specific audience or obtaining the highest click-through rate in the future etc.).

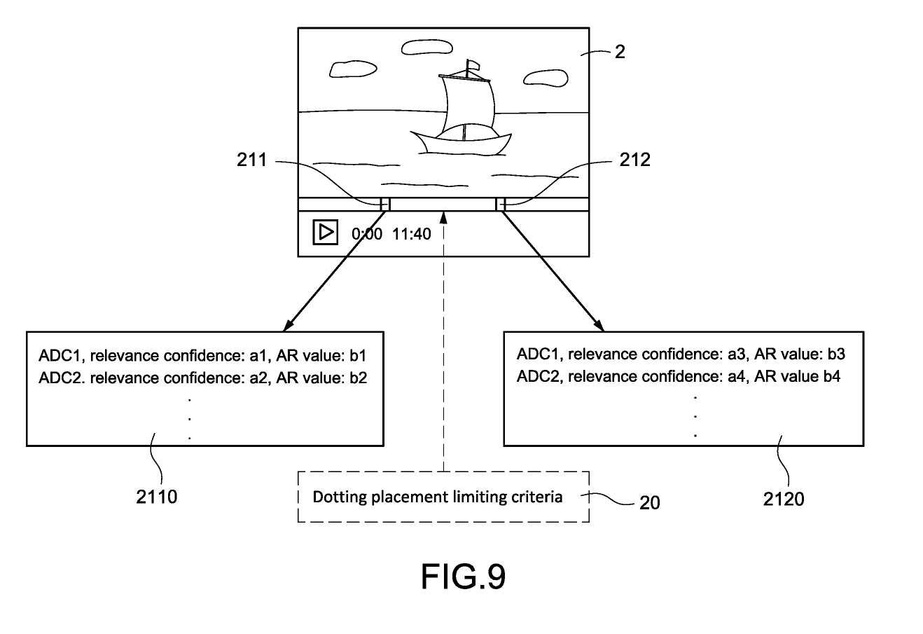

Please refer to FIG. 9, showing a schematic view of the dotting placement according to the first embodiment of the present disclosure. In an exemplary embodiment as shown in FIG. 9, the dotting model 14 of the analysis system 1 found two time sequences (corresponding to two sets of video shots) on the video 2, and the two time sequences are labeled as a first dotting placement 211 and a second dotting placement 212 respectively.

Specifically, the analysis system 1 is able to obtain relevance confidence information 2110 of the first dotting placement 211 based on a first ADC recommendation list and a first AR prediction list corresponding to the first doting placement 211. Similarly, the analysis system 1 is able to obtain relevance confidence information 2120 based on a second ADC recommendation list and a second AR prediction list corresponding to the second dotting placement 212.

As shown in FIG. 9, the relevance confidence information 2110, 2120 can include a plurality of ADCs (such as ADC1, ADC2 etc.), a plurality of relevance confidences between each ADC on the doting placement (such as a1, a2 etc.), and the predicted AR values of each ADC on the dotting placement (such as b1, b2 etc.).

In the first embodiment, the analysis system 1 may arrange the sequence of each entry of data of relevance confidence information 2110, 2120 based on the alphabet order of each ADC. In another embodiment, the analysis system 1 may arrange the sequence of each entry of data of relevance confidence information 2110, 2120 based on the level of the relevance confidences between each ADC and the dotting placement. In another embodiment, the analysis system 1 may arrange the sequence of each entry of data of relevance confidence information 2110, 2120 based on the level of the predicted AR values of each ADC for the dotting placement.

In an exemplary embodiment, the dotting model 14 uses the plurality of ADC recommendation lists 7, the dotting model 140, the plurality of AR prediction lists 9 and at least one dotting placement criteria 20 at the same time to analyze the one or several time sequences as the dotting placement (s) of the video 2.

Specifically, the dotting placement limiting criteria 20 refer to the advertisement demands made by a video operator or an advertiser, such as the time interval between the first dotting placement 211 and the second dotting placement 212 shall not be less than 10 minutes, the quantity of the dotting placement in a video 2 shall not be greater than three etc.

After the analysis system 1 finds the plurality of dotting placements 211, 212 in video 2, a comprehensive determination can be made based on the dotting placement limiting criteria 20, the category relevance confidences between each ADC and the dotting placements, and the predicted AR values of each ADC for the dotting placements in order to perform filtering and screening on the plurality of dotting placements such that the screened dotting placements are able to comply with the required dotting placement limiting criteria 20 while expecting the optimal advertising effect (such as the highest click-through rate or conversion rate).

In an exemplary embodiment, the analysis system 1 can use the Greedy Algorithm to perform the prediction of the dotting placements. Specifically, the Greedy Algorithm can find a first dotting placement with a highest predicted AR value, followed by predicting a second dotting placement and a third dotting placement forward and backward from the first dotting placement. In addition, the first dotting placement, the second dotting placement and the third dotting placement can be arranged to comply with the dotting placement limiting criteria 20. However, it can be understood that the above exemplary embodiment only illustrates one of the exemplary embodiments of the present disclosure and shall not be limited to such disclosures only.

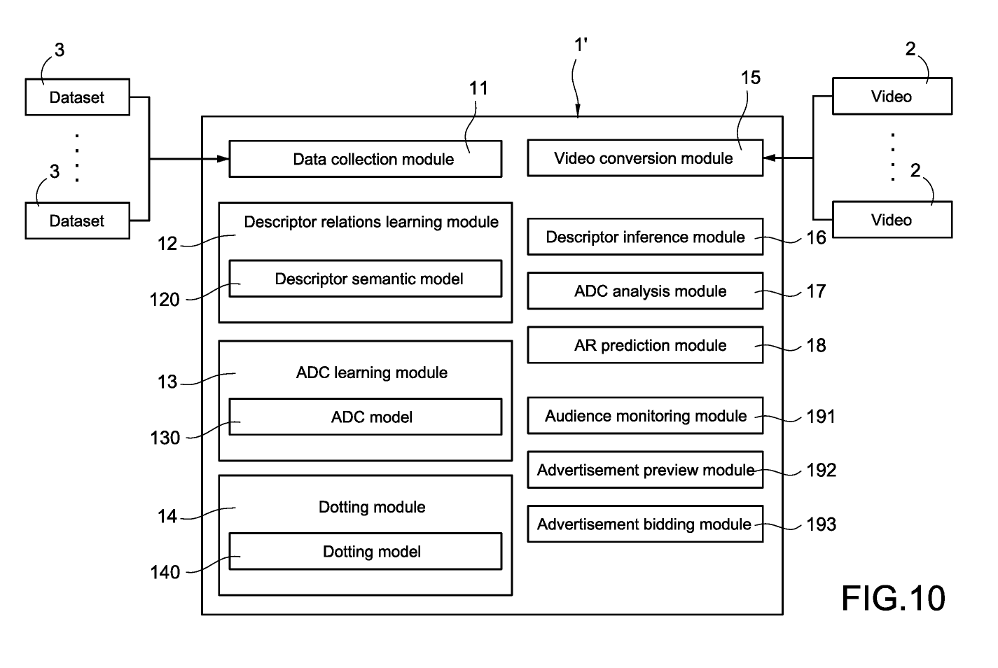

Please refer to FIG. 10, showing a schematic view of the analysis system according to the second embodiment of the present disclosure. FIG. 10 shows another analysis system 1′. The difference between the analysis system 1′ and the analysis system 1 as shown in FIG. 1 lies in that the analysis system 1′ further includes an audience monitoring module 191, an advertisement preview module 192 and an advertisement bidding module 193.

In an exemplary embodiment, the audience monitoring module 191 monitors the video with an advertisement that is already inserted at the dotting placement in order to obtain the actual response of the audience (such as whether the audience clicks the advertisement, the time of clicking through the advertisement, the time of terminating the advertisement etc.). In addition, the dotting module 14 of the analysis system 1 is able to further train the dotting model 140 based on the actual response of the audience as well as to update the individual audience behavior model 80.

The advertisement preview module 192 searches corresponding advertisement database based on the ADC that is related to each dotting placement in order to obtain one or a plurality of creatives recommended, and it is able to pre-insert the creative into the dotting placement of the video in order to provide advertisement previews for the user.

The advertisement bidding module 193 is for obtaining relevant data, such as advertisement content, advertisement shot composition, advertisement setting price and advertisement time etc., of the aforementioned one or plurality of creatives, and it is able to perform bidding on each creative in order to determine which creative to be inserted at the dotting placement of the video.

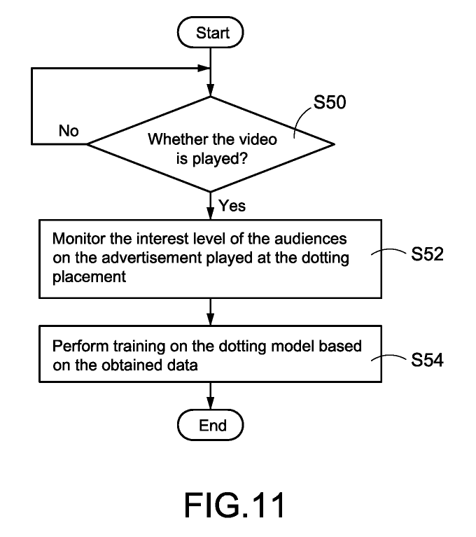

Please refer to FIG. 11, showing a video playing flowchart according to the first embodiment of the present disclosure. In an exemplary embodiment, the analysis system 1 may continue monitoring whether the video is being played after an advertisement is inserted into the video (Step S50). When the video is played, the audience monitoring module 191 may monitor the interest level of the audience for the video on the advertisement played at each dotting placement (Step S52), such as monitoring whether the audience clicks the advertisement.

After obtaining the interest level of the audience, the dotting module 14 of the analysis system 1 may perform further training on the dotting model 140 based on the obtained data (Step S54). Accordingly, the dotting model 140 is able to fit the actual status of the audience or the audience profile closely and to allow the dotting placement analyzed by the present disclosure to be more precise.

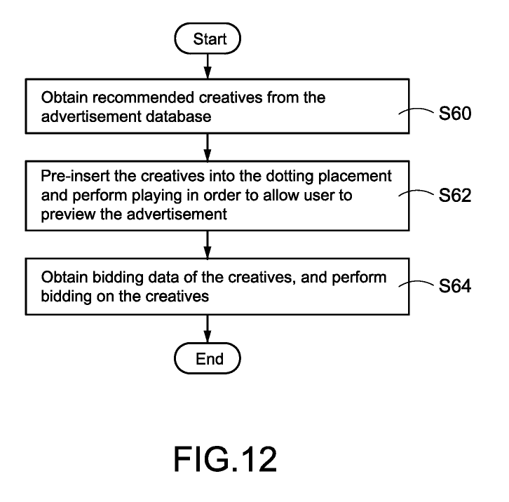

Please refer to FIG. 12, showing a dotting placement bidding flowchart according to a first embodiment of the present disclosure. In an exemplary embodiment, after analyzing and labeling the dotting placement of the video, the analysis system 1 may obtain one or a plurality of creatives and use the advertisement preview module 192 (Step S60) to pre-insert each of the obtained creatives into the dotting placement of the video for displaying in order to allow the user to perform advertisement preview (Step S62).

Next, the analysis system 1 may use the advertisement bidding module 193 to obtain the bidding data of the aforementioned one or plurality of creatives and to perform bidding for the creatives (Step S64) in order to determine which creative is to be inserted into the dotting placement of the video. Accordingly, the advertiser is able to preview the creative being displayed at each dotting placement (i.e. the present disclosure can provide a visual advertisement delivery) and perceive the impression the creative generates in order to determine the price for the advertisement slot (the placement for inserting advertisement) and to perform bidding.

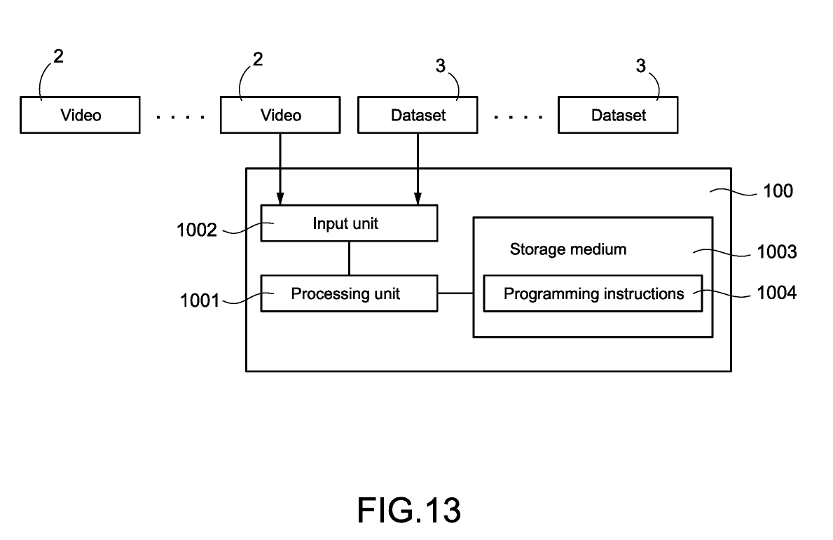

Please refer to FIG. 13, showing a schematic view of an analysis system according to the third embedment of the present disclosure. In an exemplary embodiment, another analysis system 100 is disclosed. The analysis system 100 may be, for example, a local terminal, an electronic device, a mobile device or a cloud server etc., and the present disclosure is not limited thereto.

As shown in FIG. 13, the analysis system 100 includes at a processor unit 1001, an input unit 1002 and machine readable storage medium 1003, whereas the processor unit 1001 is electronically coupled to the input unit 1002 and the storage medium 1003. The storage medium may be non-volatile.

In an exemplary embodiment, input unit 1002 is for receiving video 2 as the input to perform processes such as splitting up the video 2 into a plurality of shots and a plurality of descriptor lists 4. The input unit 1002 may also receive dataset 3 as the input to provide data for training the descriptor semantic model 120, ADC model 130 and the dotting model 140. In this embodiment, the descriptor lists 4, descriptor semantic model 120, ADC model 130 and dotting model 140 may store in the storage medium 1003.

In this embodiment, the storage medium 1003 stores programming instructions 1004 therein for a method of analyzing the video dotting placement that may be accessed by the processor unit 1001. When the programming instructions 1004 executed by the processor unit 1001, the system 100 may at least execute the following operations:

providing a video 2;

converting the content of the video 2 into a plurality of descriptor lists 4, wherein each of the descriptor lists 4 is recorded with a time sequence 41 and a plurality of raw descriptors 42 respectively, and the plurality of raw descriptors 4 is used for describing a plurality of features of video 2 appeared in the time sequence 41;

providing an advertisement category (ADC) model 130, wherein the ADC model 130 is recorded with relationships among a plurality of advertisement categories 1300 and a plurality of descriptors;

performing analysis based on the ADC model 130 and the plurality of descriptor lists 4 in order to generate a plurality of advertisement category recommendation lists 7, wherein the quantity of the plurality of advertisement category recommendation lists 7 is the same as the quantity of the plurality of descriptor lists 4, and each of the advertisement category recommendation lists 7 is respectively recorded with category relevance confidences between each of the plurality of advertisement categories 1300 and the video content corresponding to each of the time sequences 41;

calculating predicted audience response (AR) values of each of the advertisement categories 1300; and

analyzing one or multiple of the time sequences 41 as a dotting placement of the video 2 based on the plurality of advertisement category recommendation lists 7, the plurality of predicted audience response values and a dotting model 140.

By adopting the analysis systems 1, 1′ and 100, and/or the analysis method thereof, the dotting placements of the video are searched automatically based on the its content, a plurality of ADCs and the predicted AR values for each ADC. At the same time, the most relevant ADCs are recommended for each dotted placement. The high relevance of the creative to the content of the video is ensured in order to have an optimized advertising effect.

While the invention has been described in terms of preferred embodiments, those skilled in the art will recognize that the invention can be practiced with modifications within the spirit and scope of the appended claims.

What is claimed is:

1. A video dotting placement analysis method, comprising:
a) providing a video;
b) converting a content of the video into a plurality of descriptor lists, wherein each of the descriptor lists is recorded with a time sequence and a plurality of raw descriptors respectively, and the plurality of raw descriptors is used for describing a plurality of features of the video appeared in the time sequence;
c) providing an advertisement category model, wherein the advertisement category (ADC) model is recorded with relationships among a plurality of advertisement categories and a plurality of descriptors;
d) performing analysis based on the advertisement category model and the plurality of descriptor lists in order to generate a plurality of advertisement category recommendation lists, wherein a quantity of the plurality of advertisement category recommendation lists is identical to a quantity of the plurality of descriptor lists, and each of the advertisement category recommendation lists is respectively recorded with category relevance confidences between each of the plurality of advertisement categories and a video content corresponding to each of the time sequences;
e) calculating predicted audience response (AR) values of each of the advertisement categories; and
f) analyzing one or multiple of the time sequences as a dotting placement of the video based on the plurality of advertisement category recommendation lists, the plurality of predicted audience response values and a dotting model.

2. The video dotting placement analysis method according to claim 1, further comprising the following steps:
g1) after Step b, providing a descriptor semantic model formed by a plurality of base descriptors and a plurality of edges with a direction, wherein each base descriptor respectively corresponds to a predefined feature, the plurality of edges define relational strengths among the plurality of base descriptors, and the plurality of base descriptors respectively comprise the plurality of raw descriptors and the plurality of advertisement categories;
g2) obtaining one of the plurality of descriptor lists, and calculating and generating a inferred descriptor list based on the descriptor semantic model and the descriptor list obtained, wherein the inferred descriptor list is recorded with the plurality of base descriptors, and descriptor relevance confidences between each of the base descriptors and the video content corresponding to the time sequence of the descriptor list obtained;
wherein, Step d is to perform analysis based on the plurality of advertisement categories and the inferred descriptor list in order to generate one of the advertisement category recommendation lists.

3. The video dotting placement analysis method according to claim 2, further comprising the following steps:
g3) determining whether all of the plurality of descriptor lists are converted into the inferred descriptor lists; and
g4) before all of the plurality of descriptor lists are converted completely, obtaining next one of the plurality of descriptor lists for executing Step g2 again;
wherein, Step d is to perform analysis based on the plurality of advertisement categories and the plurality of the inferred descriptor lists in order to generate the plurality of advertisement category recommendation lists.

4. The video dotting placement analysis method according to claim 3, wherein Step d further comprises the following steps:
d1) selecting one of the plurality of inferred descriptor lists and performing matching with the plurality of advertisement categories in the advertisement category model in order to respectively calculate the category relevance confidences between each of the plurality of advertisement categories and the video content corresponding to the inferred descriptor list selected;
d2) determining whether all of the plurality of inferred descriptor lists are matched completely; and
d3) before all of the plurality of inferred descriptor lists are matched completely, selecting a next one of the inferred descriptor lists for executing Step d1 again.

5. The video dotting placement analysis method according to claim 4, wherein Step d1 further comprises the following steps:
d11) selecting one of the plurality of inferred descriptor lists and obtaining one of the plurality of advertisement categories;
d12) respectively calculating secondary category relevance confidences between the advertisement category and each of the base descriptors in the inferred descriptor list selected based on a predefined weight and the plurality of descriptor relevance confidences in the inferred descriptor list selected;
d13) weighting and calculating the category relevance confidence between the advertisement category and the inferred descriptor list selected based on the plurality of secondary category relevance confidences;
d14) before all of the category relevance confidences of the plurality of advertisement categories are calculated completely, obtaining a next one of the advertisement categories for again executing Step d12 and Step d13.

6. The video dotting placement analysis method according to claim 4, wherein Step e further comprises the following steps:
e1) obtaining a public behavior model;
e2) calculating a plurality of audience response prediction lists based on the public behavior model and the plurality of advertisement category recommendation lists, wherein a quantity of the plurality of audience response prediction lists is identical to a quantity of the plurality of advertisement category recommendation lists, and each of the audience response prediction lists is respectively recorded with the predicted audience response values of the plurality of advertisement categories in each of the advertisement category recommendation lists;
wherein, Step f is to analyze one or multiple of the time sequences as the dotting placement based on the plurality of advertisement category recommendation lists, the dotting model and the plurality of audience response prediction lists.

7. The video dotting placement analysis method according to claim 6, wherein the public behavior model is recorded with an analytical statistics data of at least one of a click-through rate, a visual retention time, a preference and a conversion rate of each of the advertisement categories for a general user.

8. The video dotting placement analysis method according to claim 6, further comprising a Step e0) obtaining an individual audience behavior model, wherein the individual audience behavior model is recorded with an analytical statistics data of at least one of a click-through rate, a visual retention time, a preference and a conversion rate of each of the advertisement categories for a specific user;
wherein, Step e2 is to calculate and generate the plurality of audience response prediction lists based on the public behavior model, the individual audience behavior model and the plurality of advertisement category recommendation lists jointly.

9. The video dotting placement analysis method according to claim 6, wherein Step f is to analyze one or multiple of the time sequences as the dotting placement of the video based on the plurality of advertisement category recommendation lists, the dotting model, the plurality of audience response prediction list and a dotting placement limiting criteria.

10. The video dotting placement analysis method according to claim 1, further comprising the following steps:
h) performing a dotting action on the video based on the dotting placement; and
i) listing the plurality of advertisement categories corresponding to the dotting placement, the category relevance confidences of each of the advertisement categories and the dotting placement, and the predicted audience response value of each of the advertisement categories.

11. A video dotting placement analysis system, comprising:
a video conversion module, configured to select and convert a content of the video into a plurality of descriptor lists, wherein each of the descriptor lists is respectively recorded with a time sequence and a plurality of raw descriptors, and the plurality of raw descriptors are used for describing a plurality of features appeared in the time sequence of the video;
an advertisement category analysis module, configured to obtain an advertisement category model recorded with a plurality of advertisement categories, and configured to perform analysis based on the advertisement category model and the plurality of descriptor lists in order to generate a plurality of advertisement category recommendation lists, wherein a quantity of the plurality of advertisement category recommendation lists is identical to a quantity of the plurality of descriptor lists, and each of the advertisement category recommendation lists is respectively recorded with category relevance confidences between each of the plurality of advertisement categories and a video content corresponding to each of the time sequence;
an audience response prediction module, configured to respectively calculate predicted audience response values of each of the advertisement categories; and
a dotting module, configured to analyze one or multiple of the time sequences as a dotting placement of the video based on the plurality of advertisement category recommendation lists, the plurality of predicted audience response values and a dotting model.

12. The video dotting placement analysis system according to claim 11, further comprising:
a descriptor relationship learning module, configured to train and generate a descriptor semantic model based on a plurality of datasets, wherein the descriptor semantic model is formed by a plurality of base descriptors and a plurality of edges with a direction, each of the base descriptors respectively corresponds to a predefined feature, the plurality of edges define relational strengths among the plurality of base descriptors, and the plurality of base descriptors comprise the plurality of raw descriptors and the plurality of advertisement categories;
an advertisement category learning model, configured to train and generate the advertisement category model, wherein the advertisement category model is recorded with a plurality of descriptors comprising the plurality of advertisement categories therein; the advertisement category learning model is configured to import the plurality of datasets in order to allow the advertisement category model to learn relevance strengths of each of the advertisement categories corresponding to an individual or a combination of the descriptors; and
a descriptor inference module, configured to calculate and generate a plurality of inferred descriptor lists based on the plurality of descriptor lists and the descriptor semantic model, wherein each of the inferred descriptor lists is respectively recorded with the plurality of raw descriptors, the plurality of inferred descriptors and the time sequence corresponding to each of the descriptor lists;
wherein the advertisement category analysis module is configured to perform analysis based on the plurality of advertisement categories and the plurality of inferred descriptor lists in order to generate the plurality of advertisement category recommendation lists.

13. The video dotting placement analysis system according to claim 12, wherein the advertisement category analysis module is configured to perform the following actions in order to generate the plurality of advertisement category recommendation lists:
Action 1: selecting one of the plurality of inferred descriptor lists and performing matching with the plurality of advertisement categories in the advertisement category model in order to respectively calculate the category relevance confidences between the plurality of advertisement categories and the video content corresponding to the inferred descriptor list selected;
Action 2: determining whether all of the plurality of inferred descriptor lists are matched completely; and
Action 3: before all of the plurality of inferred descriptor lists are matched completely, selecting a next one of the inferred descriptor lists for executing the Action 1 again.

14. The video dotting placement analysis system according to claim 13, wherein the Action 1 performed by the advertisement category analysis module further comprises the following actions:
Action 1-1: selecting one of the plurality of inferred descriptor lists and obtaining one of the plurality of advertisement categories;
Action 1-2: calculating respective secondary category relevance confidences between the advertisement category and each of the base descriptors in the inferred descriptor list selected based on a predefined weight and a plurality of the descriptor relevance confidences in the inferred descriptor list selected;
Action 1-3: weighting and calculating the category relevance confidence between the advertisement category and the inferred descriptor list selected based on the plurality of the secondary category relevance confidences; and
Action 1-4: before all of the category relevance confidences of the plurality of advertisement categories are calculated completely, obtaining a next one of the advertisement categories for executing the Action 1-2 and the Action 1-3 again.

15. The video dotting placement analysis system according to claim 13, wherein the audience response prediction module is configured to obtain a pubic behavior model as well as calculating and generating a plurality of audience response prediction lists based on the public behavior model and the plurality of advertisement category recommendation lists, wherein a quantity of the plurality of audience response prediction lists is identical to a quantity of the plurality of advertisement category recommendation lists, and each of the audience response prediction list is respectively recorded with the predicted audience response values of the plurality of advertisement categories in each of the advertisement category recommendation lists; wherein the dotting module is configured to analyze one or multiple of the time sequences as the dotting placement of the video based on the plurality of advertisement category recommendation lists, the dotting model and the plurality of audience response prediction lists.

16. The video dotting placement analysis system according to claim 15, wherein the public behavior model is recorded with an analytical statistics data of at least one of a click-through rate, a visual retention time, a preference and a conversion rate of each of the advertisement categories for a general user.

17. The video dotting placement analysis system according to claim 15, wherein the audience response prediction module is further configured to obtain an individual audience behavior model as well as calculating and generating the plurality of audience response prediction lists based on the public behavior model, the individual audience behavior model and the plurality of advertisement category recommendation lists jointly, wherein the individual audience behavior model is recorded with an analytical statistics data of at least one of a click-through rate, a visual retention time, a preference and a conversion rate of each of the advertisement categories for a specific user.

18. The video dotting placement analysis system according to claim 13, wherein the dotting module is configured to analyze one or multiple of the time sequences as the dotting placement of the video based on the plurality of advertisement category recommendation lists, the dotting model, the plurality of audience response prediction lists and a dotting placement limiting criteria.

19. The video dotting placement analysis system according to claim 11, wherein the dotting module is configured to perform a dotting action on the video based on the dotting placement, and is configured to list the plurality of advertisement categories corresponding to the dotting placement, the category relevance confidences between each of the advertisement categories and the dotting placement, and the predicted audience response values of each of the advertisement categories.

20. A computer readable storage medium for storing a program, wherein the program is configured to perform operations described in claim 1 when the program is executed by a processing unit.
